(19) United States
(12) Patent Application Publication
(10) Pub. No.: US 2026/0155899 A1
(43) Pub. Date: Jun. 4, 2026

(54) BATTERY COMMUNICATION SYSTEM AND OPERATION METHOD THEREOF

(71) Applicant: Grace Connection Microelectronics Limited, Zhubei City (TW)

(72) Inventors: PEI-WEI CHEN, Zhubei City (TW); Hsien-Ku CHEN, Zhubei City (TW)

(73) Assignee: Grace Connection Microelectronics Limited, Zhubei City (TW)

(21) Appl. No.: 19/365,015

(22) Filed: Oct. 21, 2025

(30) Foreign Application Priority Data
Dec. 3, 2024 (TW) 113146751

(51) Int. Cl. H04B 17/20; H01M 10/42; H04W 88/04

(52) U.S. Cl. CPC H04B 17/203; H01M 10/425; H01M 2010/4278; H04W 88/04

(57) ABSTRACT

A battery communication system and an operation method thereof are provided, wherein the battery communication system is employed to communicate with several battery units. The operation method of the battery communication system includes the following steps: in a wireless daisy chain communication path of the battery communication system, a first wireless communication unit sending a transmission signal to a second wireless communication unit adjacent thereto through an electrical/magnetic coupling wave or a wireless signal transmission; and, in the wireless daisy chain communication path of the battery communication system, the first wireless communication unit and the second wireless communication unit operating an auto-gain control (AGC) to automatically adjust a receiving gain of the second wireless communication unit.

### CROSS REFERENCE

The present invention claims priority to TW113146751 filed on Dec. 3, 2024.

### BACKGROUND OF THE INVENTION

### Field of Invention

The present invention relates to a communication system and an operation method thereof, in particular to a battery communication system and its operation method.

### Description of Related Art

To improve the efficiency of battery storage systems, most of the battery packs in today's industrial and automotive battery storage systems, primarily adopt a series connection design. As the number of batteries in the series connection increases, the DC voltage through the battery packs progressively rises. However, the battery storage systems are required to be monitored by collecting operation data such as the voltage and temperature of each individual battery, to maintain their operational safety and functionality. With the increase in series-connected DC voltage, the cross-voltage experienced by the battery energy storage communication system also rises correspondingly, which significantly increases the challenges to its safety and stability.

To the popular application of lithium iron phosphate batteries, their relatively smooth/flat discharge curves have allowed the capacity of the individual single battery to grow from a few ampere-hours (from 2 to 3 Ah) to several hundred ampere-hours (from 200 to 300 Ah). This growth brings more demands on precise battery monitoring parameters in the battery energy storage systems. Thus, the batteries are currently more and more equipped with dedicated monitoring chips.

The monitoring data from these batteries can be transmitted through a communication path to track the operation of each battery. However, the operational integrity of each node along the communication path is critical, and the battery system's communication efficiency is highly vulnerable due to any possible failure at any node along the communication path.

### SUMMARY OF THE INVENTION

In view of the aforementioned technical needs, the present invention addresses communication inefficiencies in battery systems by providing a novel battery communication system and its operation method. The system employs an auto-gain control to ensure reliable communication along the wireless daisy chain, maintaining optimal performance at each node.

According to one perspective of the present invention, an operation method of the battery communication system is provided, enabling communication with several battery units. The operation method of the battery communication system includes the following steps: in a wireless daisy chain communication path of the battery communication system, a first wireless communication unit sending a transmission signal to a second wireless communication unit adjacent thereto, via an electric/magnetic: coupling a wave or wireless signal transmission; and, in the wireless daisy chain communication path of the battery communication system, the first wireless communication unit and the second wireless communication unit operate an auto-gain control, to enable the second wireless communication unit to automatically adjust its receiving gain.

According to another perspective of the present invention, a battery communication system is proposed. The battery communication system includes a first wireless communication unit and a second wireless communication unit. The first and second wireless communication units are coupled to each other and both joined in a wireless daisy chain communication path, with the second wireless communication unit positioned adjacent to the first wireless communication unit. In the wireless daisy chain communication path of the battery communication system, the first wireless communication sends a transmission signal to the adjacent second wireless communication unit through an electric/magnetic coupling wave or a wireless signal transmission. In the wireless daisy chain communication path, the first wireless communication unit and the second wireless communication unit operate an auto-gain control (AGC) to automatically adjust a receiving gain of the second wireless communication unit.

The objectives, technical details, features, and benefits of the present invention can be better understood with regard to the detailed description of the embodiments below, with reference to the associated drawings.

### BRIEF DESCRIPTION OF THE DRAWINGS

FIG. 1 illustrates a schematic diagram of a battery system according to one embodiment of the present invention.

FIG. 2 illustrates the communication operation of the wireless daisy chain communication path according to one embodiment of the present invention.

FIG. 3 illustrates the communication operation of the wireless daisy chain communication path according to another embodiment of the present invention.

FIG. 4 illustrates a flowchart detailing the operation method of the battery communication system according to one embodiment of the present invention.

FIG. 5 illustrates a flowchart showing the details of a step S200 according to one embodiment of the present invention.

FIGS. 6A to 6B respectively illustrate the steps S100, S210, S220, and S230 according to one embodiment of the present invention.

FIG. 7 illustrates a flowchart detailing the step S200 according to one embodiment of the present invention.

FIGS. 8A to 8B respectively illustrate steps S100, S240, S250, and S260 according to one embodiment of the present invention.

### DESCRIPTION OF THE PREFERRED EMBODIMENTS

The technical wordings/terms in this specification are based on customary understanding of the art. Regarding the wording described or defined in this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

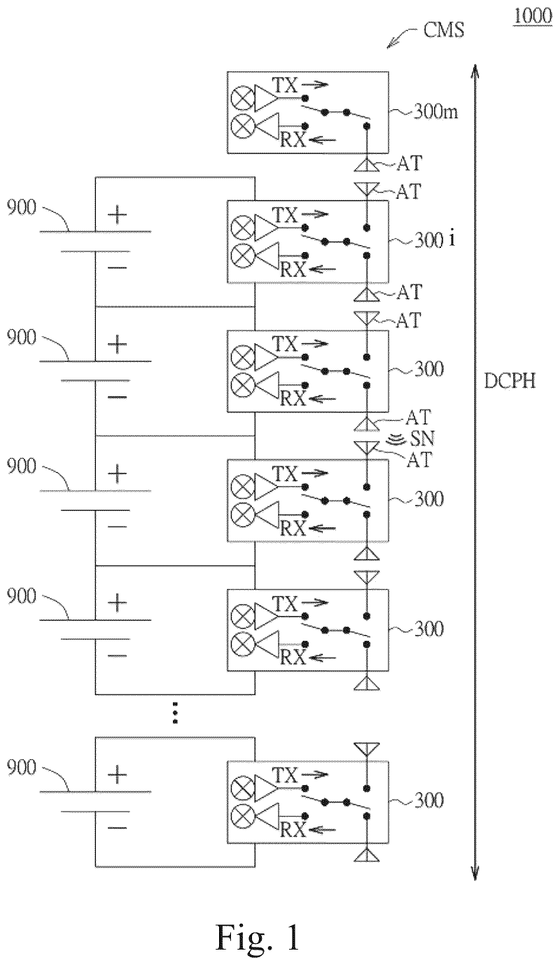

As shown in FIG. 1, a schematic diagram of a battery system 1000 according to one embodiment of the present invention is shown. The battery system 1000 includes several battery units 900 and a battery communication system CMS. The battery communication system CMS includes, for example, a main control wireless communication unit 300m and a plurality of wireless communication units 300. The battery communication system CMS connects the battery units 900. The battery units 900 are, for example, lithium iron phosphate batteries or ternary lithium batteries. The battery units 900 are connected in series. When the battery units 900 are in operation, it is necessary to monitor the battery units 900 to confirm whether the temperature, voltage, and other battery parameters are normal. In particular, when the battery units 900 employ lithium iron phosphate batteries, which exhibit a relatively smooth discharge curve, such that it becomes necessary to equip each battery unit 900 with a monitoring chip or circuit (not shown) to enable precise monitoring.

The battery communication system CMS can be employed to communicate transmission signals (e.g., monitoring information, control commands, etc.) with these battery units 900. Monitoring information can include, for example, voltage information, temperature information or electrical current information. The main wireless communication unit 300m can control these wireless communication units 300, to collect or transmit their information. The wireless coupling elements AT are located, between the facing sides of the adjacent wireless communication units 300, or the facing sides of the first wireless communication unit 300i and the main wireless communication unit 300m. A whisper wireless signal transmission between adjacent two of these wireless communication units 300, or between the main wireless communication unit 300m and the first wireless communication unit 300i, can be achieved through a wireless coupling element AT, for transmitting control commands to the wireless communication unit 300 or for returning monitoring information from them. Collectively, the wireless communication units 300 and the main wireless communication unit 300m form a wireless daisy chain communication path (DCPH). The wireless daisy chain communication path can be configured/designed as either a chain path or a loop path.

The whisper wireless signal transmission through the wireless coupling elements AT works only for the communication between adjacent wireless communication units 300 (or between the first wireless communication unit 300i and the main wireless communication unit 300m), without interfering with other wireless communication units 300 nor being subject to interference by other wireless communication units 300.

In one embodiment, each wireless communication unit 300 and the main wireless communication unit 300m can include, for example, a transmission circuit TX and a reception circuit RX. The transmission circuit TX can work for transmitting signals and the reception circuit RX can work for receiving signals. In the wireless daisy chain communication path DCPH, each wireless communication unit 300 must have stable operation. Each wireless communication unit 300 must successfully receive the transmission signal SN, to ensure an uninterrupted signal transmission along the wireless daisy chain communication path DCPH.

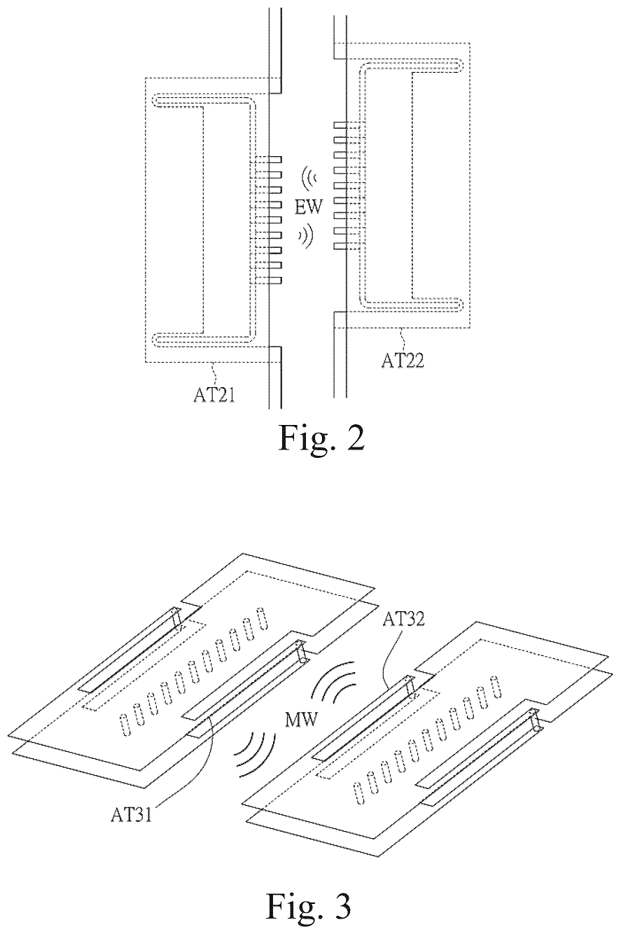

As shown in FIG. 2, a communication operation of the wireless daisy chain communication path DCPH according to one embodiment of the present invention is illustrated. As shown in FIG. 2, in the wireless daisy chain communication path DCPH, the wireless signal coupler AT21 and the wireless signal coupler AT22 can have signal transmission between each other via electric coupling wave EW.

As shown in FIG. 3, a communication operation of the wireless daisy chain communication path DCPH is illustrated, according to another embodiment of the present invention. As shown in FIG. 3, in the wireless daisy chain communication path DCPH, the wireless signal coupler AT31 and the wireless signal coupler AT32 can communicate via a magnetic coupling wave MW. Alternatively, the wireless signal couplers can employ any kind of the wireless signal transmission.

The aforementioned wireless signal coupler AT can employ the wireless signal couplers AT21, AT22 in FIG. 2 or the wireless signal couplers AT31, AT32 in FIG. 3.

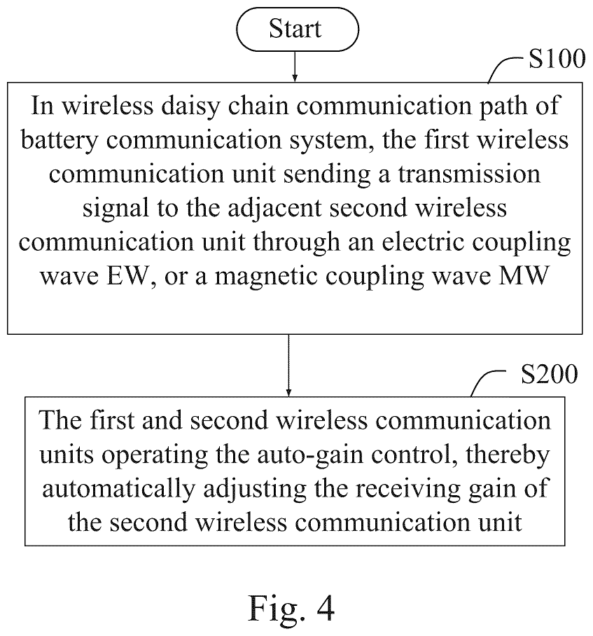

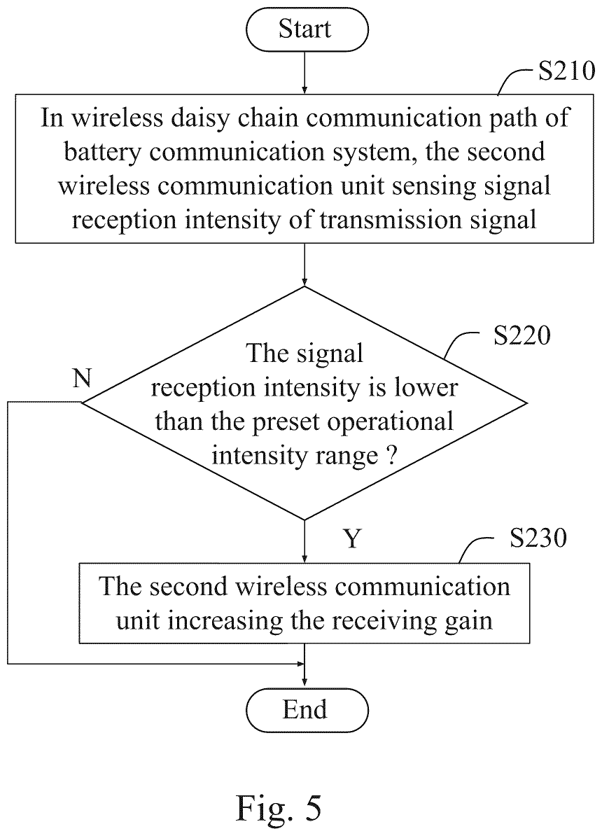

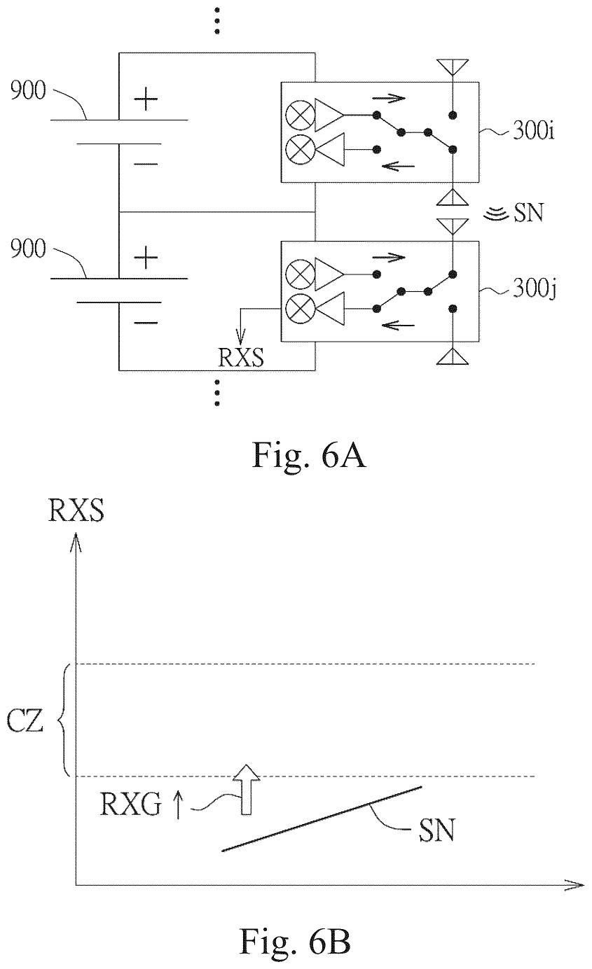

As shown in FIG. 4, a flowchart illustrates the operation method of the battery communication system CMS according to one embodiment of the present invention. The operation method of the battery communication system CMS includes steps S100 and S200, as shown in FIGS. 5, and 6A to 6B. FIG. 5 illustrates a detailed flowchart of the step S200 according to one embodiment of the present invention. The step S200 includes, for example, the steps S210 to S230. FIGS. 6A to 6B illustrate the steps S100, S210, S220, and S230.

Regarding the step S100, please refer to FIG. 6A, wherein in the wireless daisy chain communication path DCPH of the battery communication system CMS, the communication unit 300i sends the transmission signal SN to the adjacent second wireless communication unit 300j via the electric coupling wave EW (shown in FIG. 2), the magnetic coupling wave MW (shown in FIG. 3) or other wireless signal transmissions. The first wireless communication unit 300i and the second wireless communication unit 300j are two adjacent wireless communication units among the multiple wireless communication units 300 described above. The communication sequence of the first wireless communication unit 300i and the second wireless communication unit 300j is interchangeable, and the present disclosure does not impose any limitation on their order.

Then, regarding the step S200, please refer to FIG. 6B, wherein the first wireless communication unit 300i and the second wireless communication unit 300j operate an auto-gain control (AGC) to automatically adjust the receiving gain of the second wireless communication unit 300j.

In detail, the step S200 includes, the steps S210 to S230, for example. In the step S210, as shown in FIG. 6A, the second wireless communication unit 300j senses the signal reception intensity RXS of the transmission signal SN.

Then, regarding the step S220, please refer to FIG. 6B, wherein the second wireless communication unit 300j evaluates whether the signal reception intensity RXS is lower than a preset operational intensity range CZ. When the signal reception intensity RXS is too low and the receiving circuit RX cannot correctly decode the transmission signal SN, and the content of the transmission signal SN may be lost. That is, when the signal reception intensity RXS is evaluated to be lower than the preset operational intensity range CZ, it proceeds to the step S230. Therein, when the signal reception intensity is lower than the preset operational intensity range CZ, it may indicate insufficient signal strength for optimal communication capability.

In the step S230, as shown in FIG. 6B, the second wireless communication unit 300j increases the receiving gain RXG, to adjust the receiving gain RXG to enter the preset operational intensity range CZ. In one embodiment, the second wireless communication unit 300j increases the receiving gain RXG, for example, based on a preset absolute magnitude (or, with a preset absolute magnitude). After adjusting the receiving gain RXG, the flow returns to the steps S100 and S200 to re-operate the automatic gain control. When the receiving gain RXG remains lower than the preset operational intensity range CZ, the receiving gain RXG is increased (or, incrementally increased) based on the preset absolute magnitude, until receiving gain RXG reaches the preset operational range CZ.

In another embodiment, the second wireless communication unit 300j, for example, increases the receiving gain RXG based on a preset proportional factor. After adjusting the receiving gain RXG, it returns to the step S100 and the step S200 to re-operate the automatic gain control. When the receiving gain RXG is still lower than the preset operational intensity range CZ, it re-operates the auto-gain control of the step S100 and the step S200, wherein the receiving gain RXG can be increased (or, incrementally increased) based on the preset proportional factor, until the receiving gain RXG is within the preset operational range CZ.

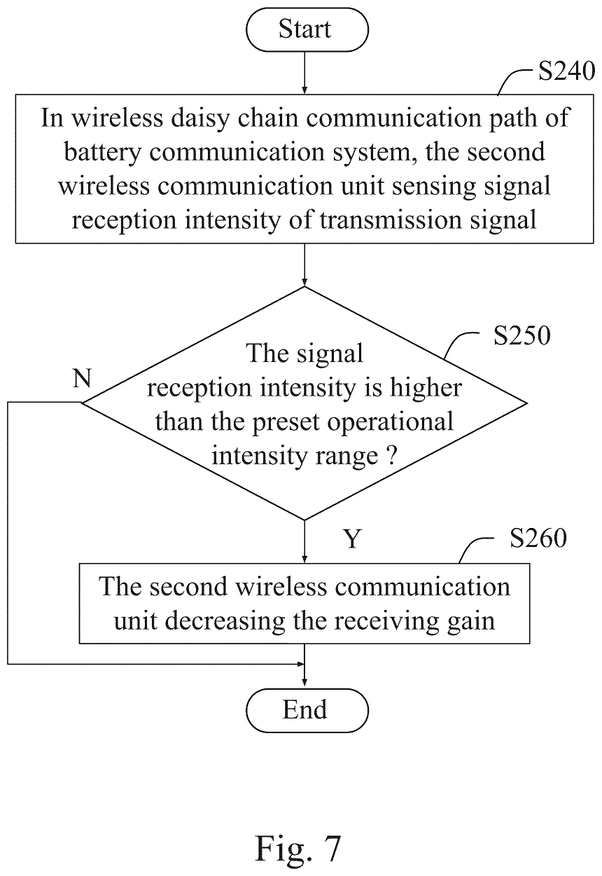

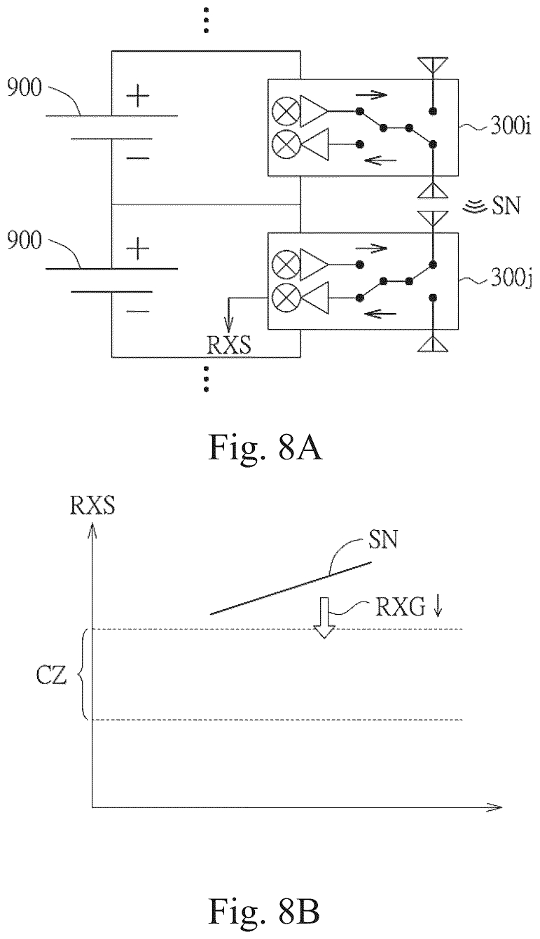

Please refer to FIGS. 7, and 8A to 8B. FIG. 7 illustrates a detail flowchart of the step S200 according to another embodiment of the present invention, wherein the step S200 includes the steps S240 to S260, for example. FIGS. 8A to 8B illustrate the steps S100, S240, S250, and S260.

Regarding the step S100, please refer to FIG. 8A, wherein in the wireless daisy chain communication path DCPH of the battery communication system CMS, the first wireless communication unit 300i sends a transmission signal SN to the adjacent second wireless communication unit through an electric coupling wave EW (shown in FIG. 2), a magnetic coupling wave MW (shown in FIG. 3) or a wireless signal transmission.

Next, please refer to FIG. 8B, wherein in the step S200, the first wireless communication unit 300i and the second wireless communication unit 300j operate the auto-gain control, thereby automatically adjusting the receiving gain RXG of the second wireless communication unit 300j.

For example, please refer to FIG. 8A, wherein the step S200 includes the steps S240 to S260. In the step S240, the second wireless communication unit 300j senses the signal reception intensity RXS of the transmission signal SN.

Then, regarding the step S250, please refer to FIG. 8B, wherein the second wireless communication unit 300j evaluates whether the signal reception intensity RXS is higher than the preset operational intensity range CZ. When the signal reception intensity RXS is too high, it may exceed an upper limit of the receiving circuit RX that can result in the inability to correctly decode the transmission signal SN, and potentially cause data loss. When the signal reception intensity RXS is higher than the preset operational intensity range CZ, the process proceeds to the step S260.

Regarding the step S260, please refer to FIG. 8B, wherein the second wireless communication unit 300j decreases the receiving gain RXG for adjusting it into the preset operational intensity range CZ. In one embodiment, the second wireless communication unit 300j decreases the receiving gain RXG, for example, based on the preset absolute magnitude. After adjusting the receiving gain RXG, the process returns to the steps S100 and S200 to re-execute the auto-gain control procedure. When the receiving gain RXG remains higher than the preset operational intensity range CZ, the receiving gain RXG will be reduced again with the preset absolute magnitude until the receiving gain RXG is not higher than (or, falls within) the preset operational intensity range CZ.

In one embodiment, the second wireless communication unit 300j decreases the receiving gain RXG based on the preset proportional factor, for example, by applying a predefined scaling coefficient. After adjusting the receiving gain RXG, the process returns to the steps S100 and S200 to re-execute the auto-gain control procedure. When the receiving gain RXG remains higher than the preset operational intensity range CZ, the receiving gain RXG will be further reduced based on a preset proportional factor until the receiving gain RXG is not higher than (or, falls within) the preset operational intensity range CZ.

In one embodiment, the step S200 includes, for example, the steps S210 to S260 as described above, ensuring that when the receiving gain RXG does not fall within w the preset operational intensity range CZ, the receiving gain RXG can be adjusted to be within the preset operational intensity range CZ by the aforementioned increasing and/or reducing operation of the receiving gain RXG.

During the operation described in the above-described embodiments, absolute adjustments for increasing and decreasing the receiving gains RXG may be substantially different (e.g., different preset absolute magnitudes or different preset proportional factors). In another point of view, the absolute adjustments for increasing and decreasing the receiving gains RXG may exhibit distinctly different effects on the system's performance. However, in another embodiment, the absolute adjustments for increasing and decreasing the receiving gain may be effectively equivalent to each other, if feasible.

There are a plurality of the wireless communication units 300 coupled to each other in the wireless daisy chain communication path DCPH, wherein the wireless communication units 300 may experience different levels of attenuation and degradation over the working time. After operating for a period of time, the wireless communication units 300 along the wireless daisy chain communication path DCPH may exhibit multiple receiving gains RXG that are not entirely identical to each other (or, the receiving gains RXG of the wireless communication units 300, exhibit slight differences from each other).

As described above, the battery communication system CMS employs the auto-gain control to ensure that each of the communication nodes in the wireless daisy chain communication path DCPH can function properly, thereby supporting the communication efficiency of the CMS.

The above description discloses distinctive features through several embodiments and/or examples for implementing the present invention. The components and configurations described above are substantially for illustrating the implementations of the present invention. These descriptions are not intended to limit the scope of the present invention. Further, repeated reference symbols or markings may appear in some embodiments for illustrative clarification purposes. Such repetition does not necessarily imply any specific relationship between the described embodiments or configurations.

The present invention has been disclosed with reference to the above the embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims.

What is claimed is:

1. An operational method of battery communication system used for communication between a plurality of battery units, the operational method including:
in a wireless daisy chain communication path of the battery communication system, a first wireless communication unit sending a transmission signal to a second wireless communication unit adjacent thereto, through an electric/magnetic coupling wave or a wireless signal transmission; and
in the wireless daisy chain communication path of the battery communication system, the first wireless communication unit and the second wireless communication unit operate an auto-gain control to automatically adjust a receiving gain of the second wireless communication unit.

2. The operation method of the battery communication system according to claim 1, wherein the auto-gain control operated by the first wireless communication unit and the second wireless communication unit, including:
in the wireless daisy chain communication path of the battery communication system, the second wireless communication unit sensing a signal reception intensity of a transmission signals;
in the wireless daisy chain communication path of the battery communication system, the second wireless communication unit evaluating whether the signal reception intensity is lower than a preset operational intensity range; and
when the signal reception intensity is evaluated to be lower than the preset operational intensity range, the second wireless communication unit increasing the receiving gain.

3. The operation method of the battery communication system according to claim 1, wherein the second wireless communication unit increases the receiving gain based on a preset absolute magnitude.

4. The operation method of the battery communication system according to claim 1, wherein the second wireless communication unit increases the receiving gain based on a preset proportional factor.

5. The operation method of the battery communication system according to claim 1, wherein the steps of the auto-gain control operated by the first wireless communication unit and the second wireless communication unit, include:
in the wireless daisy chain communication path of the battery communication system, the second wireless communication unit sensing a signal reception intensity of the transmission signals;
in the wireless daisy chain communication path of the battery communication system, the second wireless communication unit evaluating whether the signal reception intensity is higher than a preset operational intensity range; and
when the signal intensity is higher than the preset operational intensity range, the second wireless communication unit decreasing the receiving gain.

6. The operation method of the battery communication system according to claim 1, wherein the second wireless communication unit decreases the receiving gain based on a preset absolute magnitude.

7. The operation method of the battery communication system according to claim 1, wherein the second wireless communication unit decreases the receiving gain based on a preset proportional factor.

8. The operation method of the battery communication system according to claim 1, wherein an absolute adjustment for increasing the receiving gain is effectively equivalent to an absolute adjustment for decreasing the receiving gain, during corresponding gain adjustment processes.

9. The operation method of the battery communication system according to claim 1, wherein an absolute adjustment for increasing the receiving gain differs from an absolute adjustment for decreasing the receiving gain, during corresponding gain adjustment processes.

10. The operation method of the battery communication system according to claim 1, wherein the transmission signal includes: voltage information, temperature information, or electrical current information.

11. The operation method of the battery communication system according to claim 1, wherein in the wireless daisy chain communication path, the receiving gains of the plural wireless communication units are not entirely identical to each other.

12. A battery communication system, including:
a first wireless communication unit, joined in a wireless daisy chain communication path; and
a second wireless communication unit, joined in the wireless daisy chain communication path, and disposed adjacent to the first wireless communication unit;
wherein in the wireless daisy chain communication path of the battery communication system, the first wireless communication sends a transmission signal to the adjacent second wireless communication unit through an electric/magnetic coupling wave or a wireless signal transmission; and
in the wireless daisy chain communication path of the battery communication system, the first wireless communication unit and the second wireless communication unit operating an auto-gain control (AGC) to automatically adjust the receiving gain of the second wireless communication unit.

13. The battery communication system according to claim 12, wherein when operating the auto-gain control,
the second wireless communication unit sensing a signal reception intensity of the transmission signal;
the second wireless communication unit evaluating whether the signal reception intensity is lower than a preset operational intensity range; and
when the signal reception intensity is evaluated to be lower than the preset operational intensity range, the second wireless communication unit increasing the receiving gain.

14. The battery communication system according to claim 12, wherein the second wireless communication unit increases the receiving gain based on a preset absolute magnitude.

15. The battery communication system according to claim 12, wherein the second wireless communication unit increases the receiving gain based on a preset proportional factor.

16. The battery communication system according to claim 12, wherein when operating the auto-gain control,
the second wireless communication unit sensing a signal reception intensity of the transmission signal;
the second wireless communication unit evaluating whether the signal reception intensity is higher than a preset operational intensity range; and
when the signal reception intensity is higher than the preset operational intensity range, the second wireless communication unit decreasing the receiving gain.

17. The battery communication system according to claim 12, wherein the second wireless communication unit decreases the receiving gain based on a preset absolute magnitude.

18. The battery communication system according to claim 12, wherein the second wireless communication unit decreases the receiving gain based on a preset proportional factor.

19. The battery communication system according to claim 12, where an absolute adjustment for increasing the receiving gain is effectively equivalent to an absolute adjustment for decreasing the receiving gain, during corresponding gain adjustment processes.

20. The battery communication system according to claim 12, where an absolute adjustment for increasing the receiving gain differs from an absolute adjustment for decreasing the receiving gain, during corresponding gain adjustment processes.

21. The battery communication system according to claim 12, wherein the transmission signal includes: voltage information, temperature information or electrical current information.

22. The battery communication system according to claim 12, wherein, the receiving gains of the wireless communication units in the wireless daisy chain communication path, are not entirely identical to each other.
